(19) United States
(12) Patent Application Publication
(10) Pub. No.: US 2010/0155218 A1
(43) Pub. Date: Jun. 24, 2010

(54) Novel Photocatalysts that Operate Under Visible Light

(75) Inventors: Thomas Vogt, Chapin, SC (US); Sangmoon Park, Busan (KR)

Correspondence Address: DORITY & MANNING, P.A., POST OFFICE BOX 1449, GREENVILLE, SC, 29602-1449, US

(73) Assignee: UNIVERSITY OF SOUTH CAROLINA, Columbia, SC (US)

(21) Appl. No.: 12/637,050

(22) Filed: Dec. 14, 2009

Related U.S. Application Data
(60) Provisional application No. 61/121,954, filed on Dec. 12, 2008.

(51) Int. Cl. B01J 23/18; C01D 1/02; B01J 23/02

(52) U.S. Cl. 204/157.15; 502/340

(57) ABSTRACT

Semiconductor surfaces are generally provided that include a photocatalyst compound of at least one alkaline earth metal combined with bismuth and oxygen to form a bismuth oxide having a structure of AₓBi_{y}O_{z}, where A represents the at least one alkaline earth metal; 1≦x≦6; 4≦y≦6; and 7≦z≦16. The alkaline earth metal can be beryllium, magnesium, calcium, strontium, barium, and combinations thereof. Semiconductors are also generally provided having a base substrate and a semiconductor layer on the base substrate. The semiconductor layer can include any of these photocatalyst compounds. Methods are also generally described for decomposing organic material using any of these materials. The method can include, for instance, exposing a medium containing the organic material and a photocatalyst compound to visible light.

### PRIORITY INFORMATION

The present application claims priority to U.S. Provisional Patent Application No. 61/121,954 filed on Dec. 12, 2008 entitled “Novel Photocatalysts that Operate Under Visible Light” of Vogt, et al., the disclosure of which is incorporated herein by reference.

### FIELD OF INVENTION

The present application relates to the field of photocatalytic decomposition of organic and inorganic matter using semiconductors under visible light.

### BACKGROUND

A semiconductor surface heterogeneously dispersed in gas or liquid can influence the chemical reactivity of various adsorbates and thereby induce light-initiated chemical reactions with these surface-adsorbed molecules. These reactions often achieve either a specific selective or complete oxidative decomposition of organic matter. The plethora of semiconductor mediated redox reactions are often referred to as heterogeneous photocatalysis. Two types of processes are known to occur: (1) when light-induced photoexcitation occurs in an adsorbed molecule, which then interacts with the catalyst substrate a catalyzed photoreaction occurs; and (2) when the photoexcitation takes place on the catalyst substrate and subsequently an electron is transferred to the adsorbed molecule a sensitized photoreaction is taking place.

In contrast to metals, semiconductors have an energy gap in their electronic structure, where no energy levels are available to promote the recombination of an electron and hole produced by a photoexcitation. To photoexcite an electron of a metal oxide semiconductor from the valence into the conduction band, radiation energies larger than the electronic band gap are required. This band gap allows an excitation to have sufficient time (in the nanosecond regime) to transfer its charge to an adsorbed species on the semiconductor surface. In heterogeneous photocatalysis, the semiconductors remain intact and continuously transfer charge in an exothermic process to the adsorbed species. The initial step in heterogeneous photocatalysis is the creation of an electron-hole pair by exciting an electron from the valence band to the conduction band with the energy required being equal to or greater than the band gap of the semiconductor. In the case of TiO₂ in its anatase form, a bandgap of 3.2 eV corresponds to a wavelength of 387.5 nm. Light with wavelengths larger than 387.5 nm—ultraviolet radiation—will thus excite electrons, while leaving back a hole in the conduction band. This creation of an electron-hole pair is the basis for subsequently generating hydroxyl radical and biradical oxygen. Visible light ranges from about 3.0 eV (violet) to 1.8 eV (red). The peak power of the sun is in the yellow region near 2.5 eV.

After photoexcitation, various charge transfer reactions can occur: electrons or holes can migrate to the surface and then transfer onto the adsorbed species. At the surface, donated electrons will reduce electron acceptors, often oxygen in an aerated solution. In contrast, a hole will combine with an electron donor, thus oxidizing the donor species. Electron-hole recombinations on the surface or in the bulk are competing reactions.

An important aspect of heterogeneous photocatalysis is the photodecomposition of water. Water cannot be photodecomposed on clean TiO₂ surfaces. The band edge positions of TiO₂ relative to the electrochemical potential of the H₂/H₂O and O₂/H₂O redox couples indicates a large overpotential for the evolution of both gases. Wet TiO₂ showing hydrogen evolution is possible due to the photoassisted oxidation of oxygen vacancies on reduced TiO₂₋ₓ. However, sustained photodecomposition of water can be achieved under three main experimental conditions:
(1) A photoelectrochemical cell using a TiO₂ anode and a metal cathode (Pt in many cases) can be used. In this case hydrogen will evolve from Pt and oxygen from TiO₂. A small external bias (>0.25V) may be required. However, this bias is significantly smaller than the one required in an electrochemical cell for the electrolysis of water (>1.23V). After the photoexcitation in TiO₂, the electrons in the conduction band flow through an external circuit to the metal cathode where water molecules will be reduced to hydrogen and the holes remain in the TiO₂ anode and will oxidize water to oxygen.
(2) In TiO₂ particles with catalysts deposited on their surface to promote H₂ evolution (i.e. Pt) and O₂ evolution (i.e. RuO₂) the system is essentially a short-circuited photoelectrochemical. After photoexcitation, the electrons from the conduction band are injected into the Pt anode and the holes move into the RuO₂ cathode. Trapped electrons in Pt reduce water to hydrogen and trapped holes in RuO₂ particles oxidize water to oxygen.
(3) The use of a sacrificial species to remove one of the photodecomposition products will kinetically drive the reaction. This sacrificial species may be oxidized by the hole reaction or reduced by the electron reaction. If methanol is added to an aqueous TiO₂ suspension, H₂ evolution is observed under UV irradiation and the alcohol is oxidized to CO₂.

In 1972 Fijishima and Honda demonstrated the first complete water photoelectrolysis by using n-TiO₂ with a small electrical bias to compensate for the insufficient reducing power of the electrons in the conduction band to drive a water reduction at the cathode as described above. Subsequently Wrighton used n-SrTiO₃, which has a higher conduction band energy than TiO₂ and did not require an electrical bias. Both solar energy harvesting and waste water remediation are being pursued along a general strategy where an electron-hole pair is created, where the electron promoted into the conduction band will reduce an acceptor, while the hole left behind in the valence band will oxidize a donor. In many cases, catalysts such as Pt are added to facilitate the redox process after the electron-hole formation as mentioned above.

The photocatalytic decomposition of organic matter with ultraviolet or preferably visible light is used in wastewater remediation. Although the use of chlorine for water disinfection provides a route to reduce the organic carbon levels, unacceptable levels of chlorinated hydrocarbons are generated. Further applications are the destruction of chemical warfare agents or sterilization of surgical equipment and surfaces (i.e. tiles). Ireland et. al. first reported the inactivation of microorganisms in aqueous solutions using TiO₂ as a photocatalyst. This was attributed to the creation of strongly oxidizing OH radicals. Zhang et. al. demonstrated the photocatalytic inactivation of Escherichia coli in water under UV-light and in the presence of TiO₂.

It is attractive due to the low cost of producing UV or visible light to photolyze chemical bonds in water and thereby create highly reactive OH radicals which subsequently will oxidize organic matter into less toxic species by an advanced oxidation process (AOP). Photocatalytic processes using metal oxide semiconductors and light are the most effective way to promote an AOP. Efficient, cheap and nontoxic photocatalysts operating under visible light will enable the development and large scale implementation of “green” photocatalysis for the treatment of various contaminations.

### SUMMARY

Objects and advantages of the invention will be set forth in part in the following description, or may be obvious from the description, or may be learned through practice of the invention.

In general, the present disclosure is directed toward a novel class of metal oxide semiconductors and their use as photocatalysts operating under visible light to decompose organic and inorganic matter.

Semiconductor surfaces are generally provided that include a photocatalyst compound of at least one alkaline earth metal combined with bismuth and oxygen to form a bismuth oxide having a structure of AₓBi_{y}O_{z}, where A represents the at least one alkaline earth metal; 1≦x≦6; 4≦y≦6; and 7≦z≦16. The alkaline earth metal can be beryllium, magnesium, calcium, strontium, barium, and combinations thereof. In one particular embodiment, the alkaline earth metal is a single alkaline earth metal selected from the group consisting of calcium, strontium, and barium. For example, suitable bismuth oxides can have the structures: A₆Bi₆O₁₅, where A is Ca, Sr, or a mixture of Ca, Sr, and/or Ba; A₄Bi₆O₁₃, where A is Ca, Sr, or a mixture of Ca, Sr, and/or Ba; ABi₆O₁₀, where A is Ca or a mixture of Ca, Sr, and/or Ba; A₃ Bi₄O₉, where A is Sr or a mixture of Ca, Sr, and/or Ba; ABi₄O₇, where A is Sr or a mixture of Sr, Ca, and/or Ba; or mixtures or combinations thereof. For example, specific suitable bismuth oxides include, but are not limited to, Ca₆ Bi₆O₁₅, Sr₆Bi₆O₁₅, Ca₄Bi₆O₁₃, CaBi₆O₁₀ and mixtures and combinations thereof.

Semiconductors are also generally provided having a base substrate and a semiconductor layer on the base substrate. The semiconductor layer can include any of these photocatalyst compounds described above.

Methods are also generally described for decomposing organic material using any of these photocatalyst compounds described above. The method can include, for instance, exposing a medium (e.g., an aqueous or non-aqueous solution, suspension, dispersion, etc.) containing the organic material and a photocatalyst compound to visible light.

Other features and aspects of the present invention are discussed in greater detail below.

### BRIEF DESCRIPTION OF THE FIGURES

A full and enabling disclosure of the present invention, including the best mode thereof to one skilled in the art, is set forth more particularly in the remainder of the specification, which includes reference to the accompanying figures, in which:

FIG. 1 shows plots for absorbance as a function of wavelength (nm) for various compounds formed according to the examples described below;

FIG. 2 shows the concentration curve (concentration in a.u. vs. time in miniutes) of various examples described below;

FIG. 3 shows the adsorption (in a.u.) as a function of wavelength of TiO₂, Ca₆Bi₆O₁₅, Ca₄Bi₆O₁₃, CaBi₂O₄, CaBi₆O₁₀, mixture, SrBi₂O₄, and Sr₂Bi₂O₅ according to the examples described below;

FIG. 4 shows the photocatalytic degradation of methylene blue (2×10−5 M) under visible light according to the examples described below;

FIG. 5 shows the apparent first order linear function of Ln (C₀/C) vs. time (min) for the methylene blue degradation reaction over catalysts according to the examples described below; and

FIG. 6 shows the X-ray diffraction patterns of (a) CaBi₆O₁₀, (b) CaBi₂O₄, (c) Ca₄Bi₆O₁₃, (d) Ca₆Bi₆O₁₅, (e) mixture according to the examples described below.

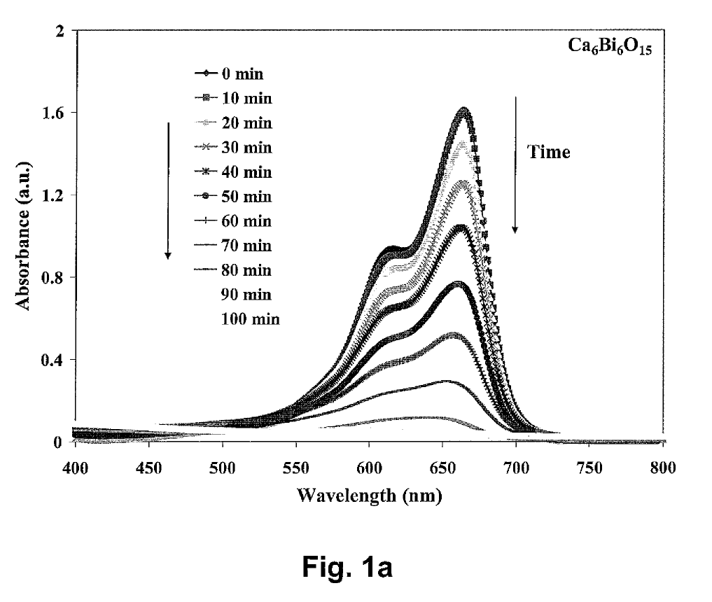

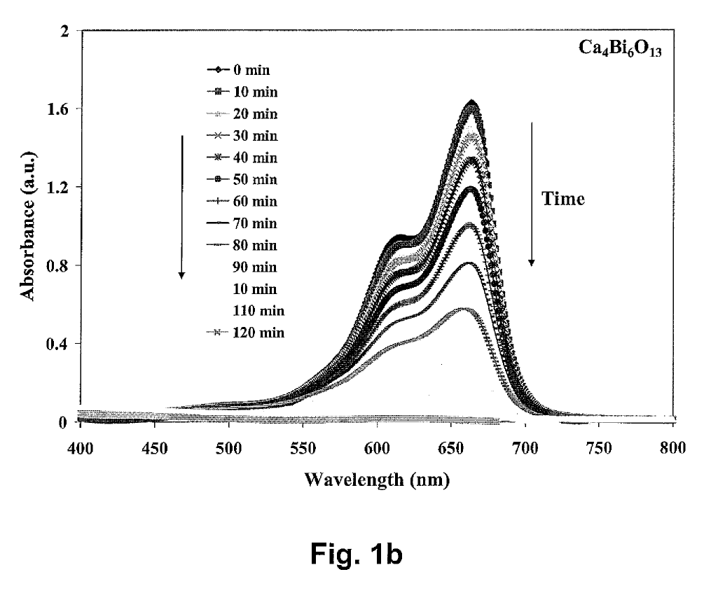

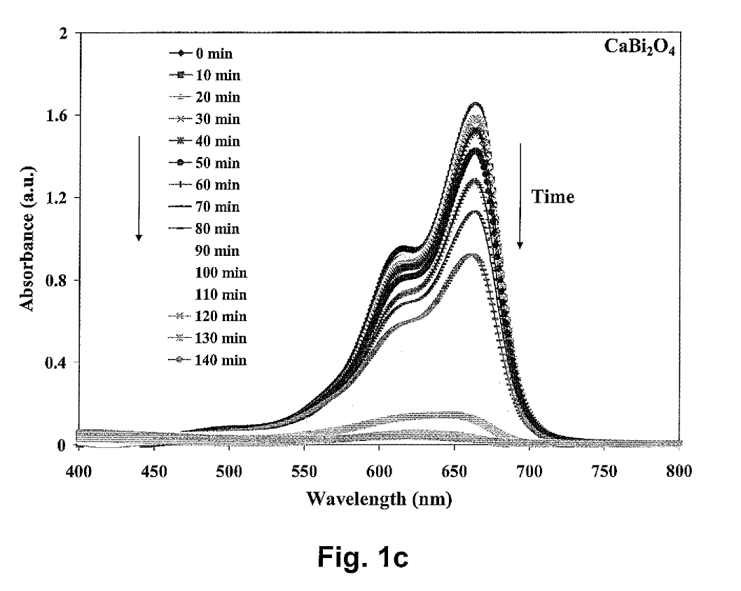

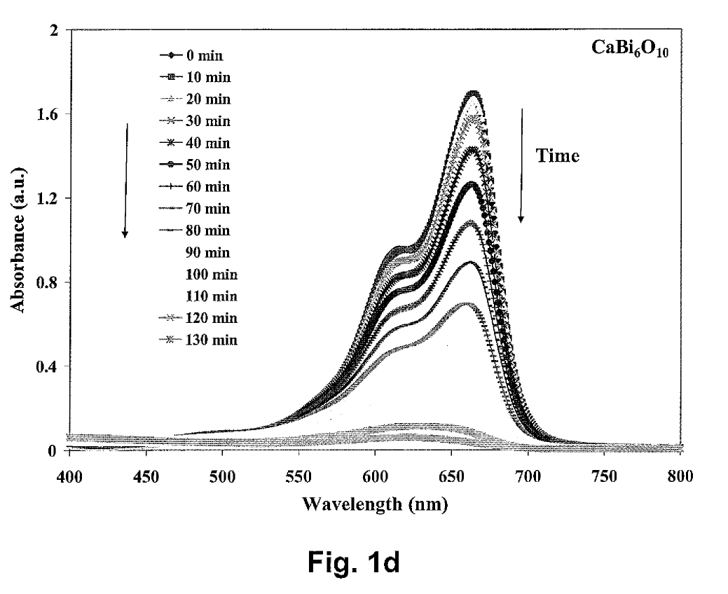

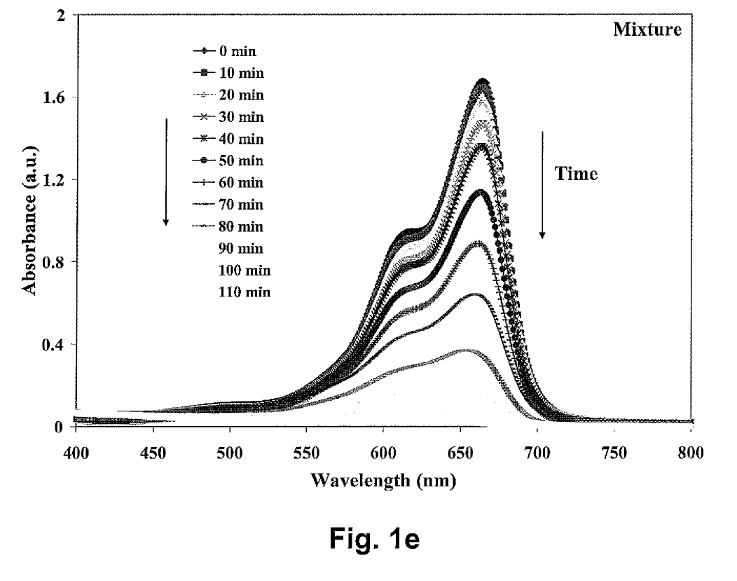

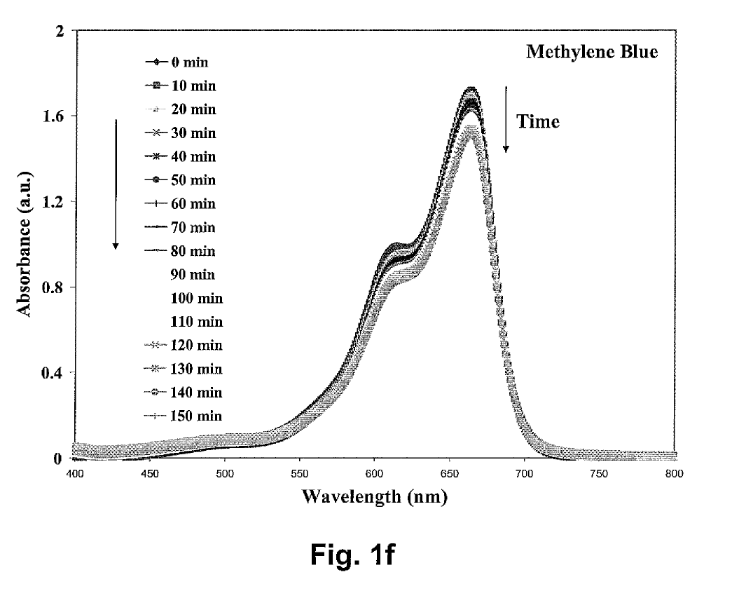

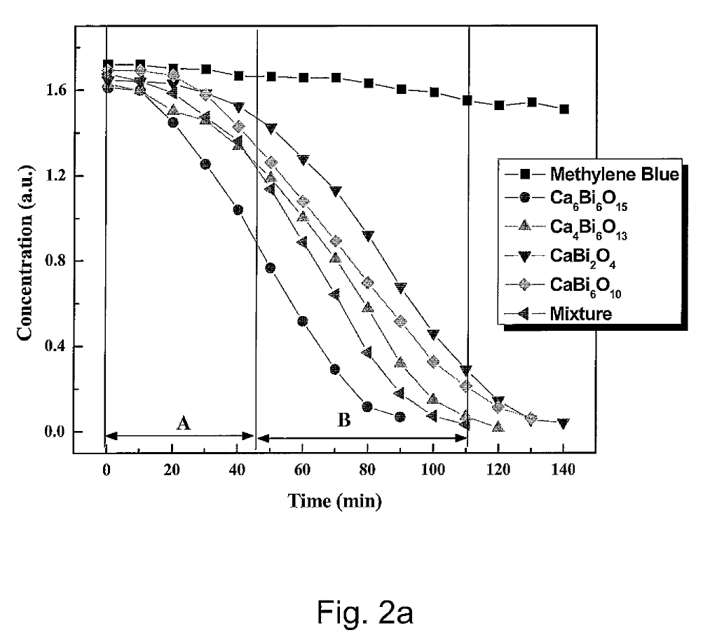

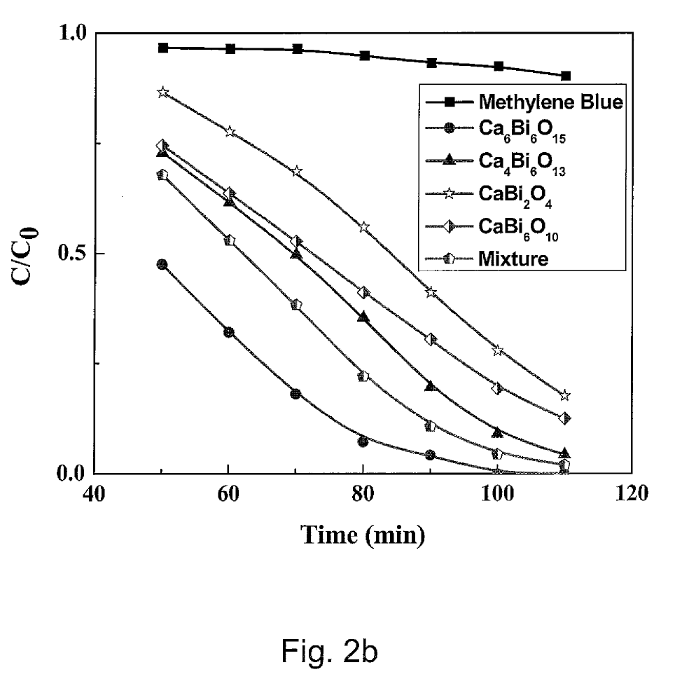

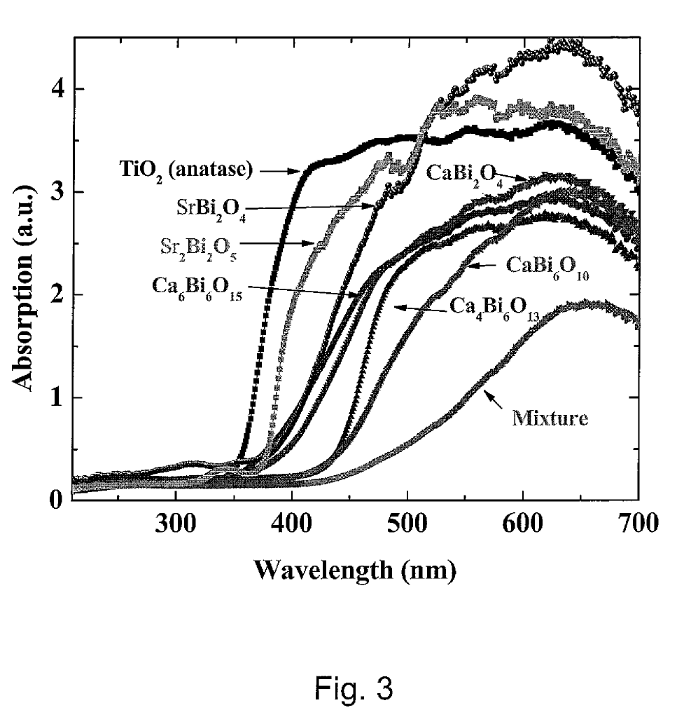

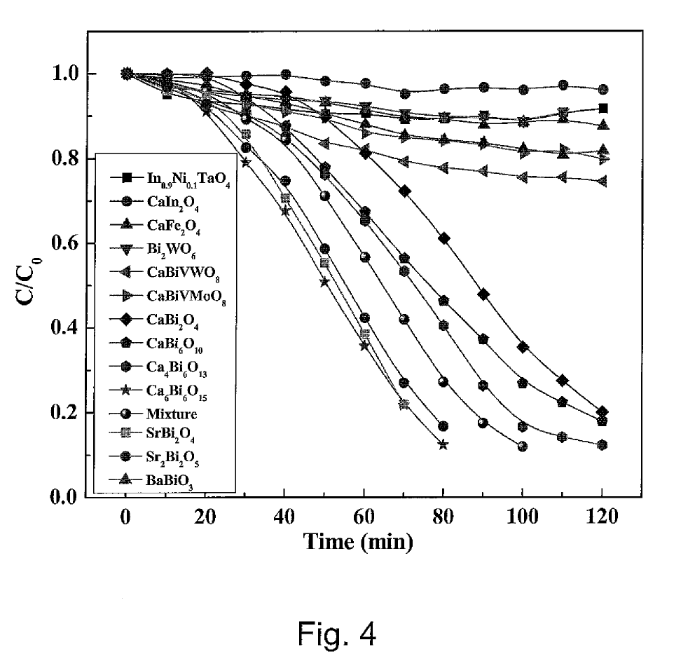

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

Generally speaking, the present invention is directed to photocatalyst compounds configured to operate under visible light (e.g., from about 380 nm to about 750 nm). These materials can be made cheaply, in large quantities and are non-toxic. They can be used in a variety of applications in which cheap and environmentally benign photocatalysts are needed to decompose organic compounds. Photocatalytic decomposition works at room temperature, requires no additives and can lead to the complete oxidation of organics to CO₂ and H₂O. These photocatalysts will be applicable to photoremediate a wide variety of organics, microbes, viruses, and germs.

The photocatalyst compounds are formed using at least one element from “Group 2” of the periodic table (i.e., the alkaline earth metals). Group 2 alkaline earth metals include beryllium (Be), magnesium (Mg), calcium (Ca), strontium (Sr), barium (Ba), and radium (Ra). However, the last element, radium, is radioactive and is not considered practical for the present invention. Of these group 2 alkaline earth metals calcium (Ca), strontium (Sr), and barium (Ba) are preferred.

The group 2 alkaline earth metals are combined with bismuth and oxygen to form the photocatalyst compound, as a bismuth oxide.

The particular stoichiometry of the formed photocatalyst compound may vary. For example, families and compositions of bismuth oxides and mixtures thereof suitable for use according to the present invention include, but are not limited to: (1) A₆Bi₆O₁₅ (A=Ca, Sr or mixtures of Ca, Sr, and Ba); (2) A₄Bi₆O₁₃ (A=Ca, Sr and mixtures of Ca, Sr and Ba); (3) ABi₆O₁₀ (A=Ca and mixtures of Ca, Sr and Ba); (4) A₃Bi₄O₉ (A=Sr, and mixtures of Ca, Sr and Ba) and (5) ABi₄O₇ (A=Sr and mixtures of Sr, Ca and Ba).

Particular examples of the photocatalyst compounds for use in visible light of the present invention include Ca₆Bi₆O₁₅, Sr₆Bi₆O₁₅, Ca₄Bi₆O₁₃ and CaBi₆O₁₀.

The photocatalyst compounds can be applied as a semiconductor layer on a base substrate to form a semiconductor. The base substrate refers the base or supporting material(s) to which additional layers or materials are applied (e.g. the photocatalyst compounds). The base substrates can be made from silicon, sapphire, and other suitable materials.

Organic material can be decomposed using the photocatalyst compounds. In particular, a medium (e.g., a liquid or gas) that includes the organic material can be exposed to the photocatalyst compound (e.g., a semiconductor having a layer of photocatalyst compounds) and to visible light (i.e., light having a wavelength from about 380 nm to about 750 nm). For instance, the medium can be, in particular embodiments, a liquid such as an aqueous solution, an aqueous suspension, or an aqueous dispersion.

### EXAMPLES

Ca₆Bi₆O₁₅, Ca₄Bi₆O₁₃, CaBi₂O₄, and CaBi₆O₁₀ were prepared by a solid-state reaction method. Successive heat treatments (600° C. (1 h), 700° C. (16 h), 750° C. (18 h), 800° C. (1 d), 850° C. (19 h) for Ca₆Bi₆O₁₅; 600° C. (1 h), 700° C. (16 h), 750° C. (18 h) for Ca₄Bi₆O₁₃; 650° C. (0.5 h), 700° C. (18 h), 750° C. (1 d) for CaBi₂O₄; 600° C. (1 h), 700° C. (1d) for CaBi₆O₁₀) with intermediate mixing and grinding of CaCO₃ and Bi₂O₃ were preformed for preparing the best stoichiometric calcium bismuth oxide compositions. The single-phase of 5 g-scale Ca₆Bi₆O₁₅ was obtained by heating of CaCO₃ and Bi₂O₃ at 600° C. for 1 h and twice at 850° C. for 1 d and 19 h.

SrBi₂O₄, Sr₂Bi₂O₅, BaBiO₃, and CaFe₂O₄ were prepared by a solid-state reaction method. SrBi₂O₄ and Sr₂Bi₂O₅ were prepared by stoichiometric mixing together with SrCO₃ (alfa 99%) and Bi₂O₃ and successive heating and grinding at 600° C. (1 h), 800° C. (19 h), 800° C. (1 d) and 600° C. (1 h), 700° C. (1 d), 850° C. (1 d), respectively. The single phase of BaBiO₃ was synthesized by heating of BaCO₃ (alfa 99.8%) and Bi₂O₃ with three intermittent grinding at 600° C. for 1 h, 21 h, 23 h and then finally annealed at 600° C. for 3 d. The mixed powders of CaCO₃ and Fe₂O₃ (alfa 99.945%) for the CaFe₂O₄ compound were heated up to 1000° C. for 1 d with intermediate grinding and heating twice at 800° C. for 1 d and 900° C. for 1 d.

The following known visible photocatalysts were synthesized to compare their performance in the photocatalytic decomposition of methylene blue (used as a representative “model pollutant” herein):

Bi₂WO₆ was made by heating of Bi₂O₃ (Alfa 99.99%) and WO₃ (Alfa 99.8%) at 900° C. for 1 day in air with intermediate grinding and heating at 600° C. for 1 h.

Bi₂O₃ and V₂O₅ (alfa 99.6%) were used as starting materials for BiVO₄. The mixture was sintered at 700° C. for 1 day with intermediate grinding and heating at 600° C. for 1 h.

The stoichiometric mixtures of CaCO₃ (alfa 99%), Bi₂O₃, V₂O₅, WO₃ and/or MoO₃ (alfa 99.95%) for CaBiVWO₈ and CaBiVMoO₈ were preheated at 600° C. for 2 h and then calcined at 800° C. for 18 h.

CaIn₂O₄, InTaO₄ and In_{0.9}Ni_{0.1} TaO₄ were synthesized by stoichiometric mixing of CaCO₃, In₂O₃ (alfa 99.9%), Ta₂O₅ (alfa 99.993%), and/or NiO (alfa 99%) and successive heat treatments at 1050° C. and 1100° C. for 15 h, respectively.

The following experiment was used to compare the photocatalytic activity of various compounds:

Methylene blue in the range of 5-10 ppm was used as a “model pollutant” and thus its photooxidation provided a sound testing ground for textile wastewater remediation. A ‘blank run’ indicated that methylene blue does decompose slightly under visible light but not under UV illumination. Our data using visible light was corrected for the decomposition without the presence of a photocatalyst.

The decolorization of methylene blue (MB, 2×10⁻5 M) was used as a screening method for the photocatalytic evaluation of all samples under visible light in this work as shown in the attached Figures. We used the same 50 W UV-filtered halogen lamp as a visible light source. About 0.2 g samples made as pellets using 4 tons pressure were used in the form of half inch diameter pellets. Subsequently they were cut and approximately 0.065 g samples were used in the photocatalysis screening experiment. 3 mL of methylene blue (MB) and a sample prepared as described above were placed at the bottom of a disposable cuvette (UV grade polymethylmethacrylate PMMA, 280-800 nm). The light was turned on without equilibrium time between the catalysts and MB solution. The distance from light to the bottom of cuvette was about 4 inches and this experiment was performed at ambient temperature (˜34° C.). No convection was introduced during these experiments. Ultraviolet-visible spectroscopy was used for the absorption measurements (Spectrofluoromether Fluorat-02-Panorama) following the MB decolorization from 400 to 800 nm in appropriate time steps. This allowed the photodecomposition of MB to be plotted as a function of time using each maximum peak.

As shown in the attached Figures, the photocatalytic activity measured by decomposing methylene blue varies considerably among the various Ca—Bi—O phases. The most photocatalytically active phase under visible light is Ca₆Bi₆O₁₅. The only known photocatalysts in this system are CaBi₂O₄ and SrBi₂O₄ (Japanese Patent Application 2004358332). CaBi₂O₄ is shown to have about a third less photocatalytic activity than Ca₆Bi₆O₁₅ and Ca₄Bi₆O₁₃. A third phase CaBi₆O₁₀ and a mixture of Ca₄Bi₆O₁₃ and CaBi₂O₄ show a lower photocatalytical activity. We also establish that the phase Sr₆Bi₆O₁₅ has very good photocatalytic activity compared to the known SrBi₂O₄.

TABLE 1
Crystal structure and band-gap.

| | | Band Gap | Reference |
|---|---|---|---|
| Photocatalysts | Crystal Structure | (E_{g}, eV) | for E_{g} |
| TiO₂ (Anatase) | Tetragonal | 3.3 | this work |
| In_{0.9}Ni_{0.1}TaO₄ | Monoclinic | 2.3 | 10 |
| CaIn₂O₄ | Orthorhombic | 3.9 | 11 |
| CaFe₂O₄ | Orthorhombic | 1.9 | 12 |
| Bi₂WO₆ | Orthorhombic | 2.75 | 13 |
| BiVO₄ | Monoclinic | 2.4 | 14 |
| CaBiVWO₈ | — | 2.51 | 15 |
| CaBiVMoO₈ | — | 2.41 | 15 |
| BaBiO₃ | Monoclinic | 2 | 16 |
| Ca₆Bi₆O₁₅ | Triclinic | 2.9 | this work |
| Ca₄Bi₆O₁₃ | Orthorhombic | 2.7 | this work |
| CaBi₂O₄ | Monoclinic | 2.8 | this work |
| CaBi₆O₁₀ | Orthorhombic | 2.6 | this work |
| Mixture | — | 2.1 | this work |
| SrBi₂O₄ | Monoclinic | 2.9 | this work |
| Sr₂Bi₂O₅ | Orthorhombic | 3.1 | this work |

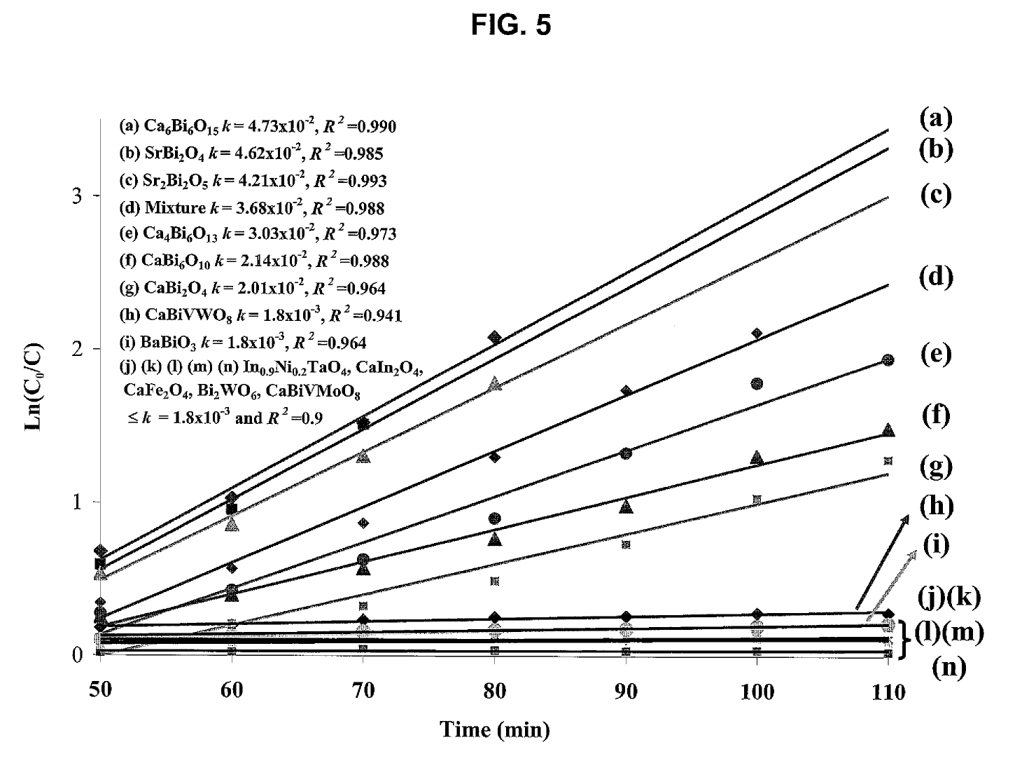

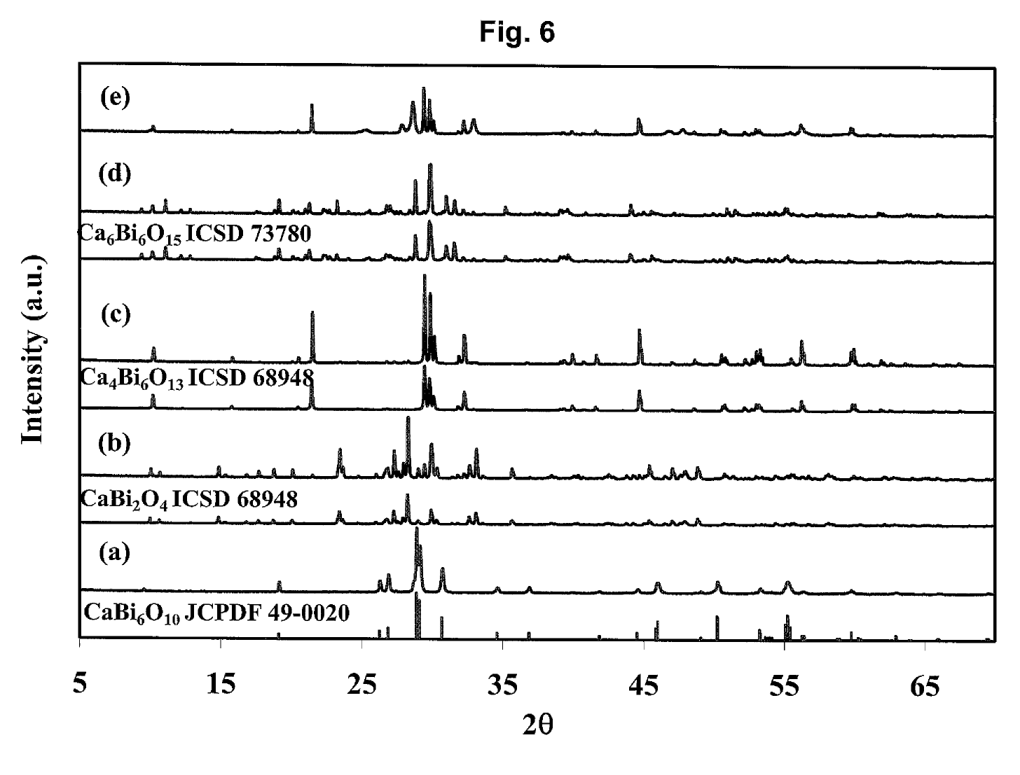

TABLE 2
The summary of photocatalysts with kₐₚₚ calculation.

| | | |
|---|---|---|
| Compounds | kₐₚₚ (R²) | in FIG. 5 |

| TiO₂ (Anatase) | — | | — |
|---|---|---|---|
| In_{0.9}Ni_{0.1}TaO₄ | ≦1.8 × 10⁻³ | (0.9) | j |
| CaIn₂O₄ | ≦1.8 × 10⁻³ | (0.9) | k |
| CaFe₂O₄ | ≦1.8 × 10⁻³ | (0.9) | l |
| Bi₂WO₆ | ≦1.8 × 10⁻³ | (0.9) | m |
| CaBiVWO₈ | 1.8 × 10⁻³ | (0.941) | h |
| CaBiVMoO₈ | ≦1.8 × 10⁻³ | (0.9) | n |
| BaBiO₃ | 1.8 × 10⁻³ | (0.964) | i |
| Ca₆Bi₆O₁₅ | 4.73 × 10⁻² | (0.990) | a |
| Ca₄Bi₆O₁₃ | 3.03 × 10⁻² | (0.973) | e |
| CaBi₂O₄ | 2.01 × 10⁻² | (0.964) | g |
| CaBi₆O₁₀ | 2.14 × 10⁻² | (0.988) | f |
| Mixture | 3.68 × 10⁻² | (0.988) | d |
| SrBi₂O₄ | 4.62 × 10⁻² | (0.985) | b |
| Sr₂Bi₂O₅ | 4.21 × 10⁻² | (0.993) | c |

The foregoing description of the invention and examples along with other modifications and variations to the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention.

1. A semiconductor surface comprising a photocatalyst compound comprising at least one alkaline earth metal combined with bismuth and oxygen to form a bismuth oxide having a structure of AₓBi_{y}O_{z}, where A represents the at least one alkaline earth metal; 1≦x≦6; 4≦y≦6; and 7≦z≦16.

2. The semiconductor surface of claim 1, wherein the at least one alkaline earth metal comprises beryllium, magnesium, calcium, strontium, barium, and combinations thereof.

3. The semiconductor surface of claim 1, wherein the at least one alkaline earth metal comprises calcium, strontium, barium, and combinations thereof.

4. The semiconductor surface of claim 1, wherein the at least one alkaline earth metal is a single alkaline earth metal selected from the group consisting of calcium, strontium, and barium.

5. The semiconductor surface of claim 1, wherein the at least one alkaline earth metal is calcium.

6. The semiconductor surface of claim 1, wherein the at least one alkaline earth metal is strontium.

7. The semiconductor surface of claim 1, wherein the at least one alkaline earth metal is barium.

8. The semiconductor surface of claim 1, wherein the bismuth oxide has the structure: A₆Bi₆O₁₅, where A is Ca, Sr, or a mixture of Ca, Sr, and/or Ba.

9. The semiconductor surface of claim 1, wherein the bismuth oxide has the structure: A₄Bi₆O₁₃, where A is Ca, Sr, or a mixture of Ca, Sr, and/or Ba.

10. The semiconductor surface of claim 1, wherein the bismuth oxide has a structure: ABi₆O₁₀, where A is Ca or a mixture of Ca, Sr, and/or Ba.

11. The semiconductor surface of claim 1, wherein the bismuth oxide has the structure: A₃Bi₄O₉, where A is Sr or a mixture of Ca, Sr, and/or Ba.

12. The semiconductor surface of claim 1, wherein the bismuth oxide has the structure: ABi₄O₇, where A is Sr or a mixture of Sr, Ca, and/or Ba.

13. The semiconductor surface of claim 1, wherein the bismuth oxide has the structure: Ca₆Bi₆O₁₅.

14. The semiconductor surface of claim 1, wherein the bismuth oxide has the structure: Sr₆Bi₆O₁₅.

15. The semiconductor surface of claim 1, wherein the bismuth oxide has the structure: Ca₄Bi₆O₁₃.

16. The semiconductor surface of claim 1, wherein the bismuth oxide has the structure: CaBi₆O₁₃.

17. A semiconductor comprising
a base substrate; and
a semiconductor layer comprising a photocatalyst compound comprising at least one alkaline earth metal combined with bismuth and oxygen to form a bismuth oxide having a structure of AₓBi_{y}O_{z}, where A represents the at least one alkaline earth metal; 1≦x≦6; 4≦y≦6; and 7≦z≦16.

18. A method of decomposing organic material, the method comprising exposing a medium comprising the organic material and a photocatalyst compound to visible light, wherein the photocatalyst compound comprises at least one alkaline earth metal combined with bismuth and oxygen to form a bismuth oxide having a structure of AₓBi_{y}O_{z}, where A represents the at least one alkaline earth metal; 1≦x≦6; 4≦y≦6; and 7≦z≦16.

19. The method of claim 18, wherein the medium is an aqueous solution, an aqueous suspension, or an aqueous dispersion.

20. The method of claim 18, wherein the photocatalyst compound is located on a surface of a semiconductor.
